(19) United States
(12) Patent Application Publication
(10) Pub. No.: US 2003/0102030 A1
(43) Pub. Date: Jun. 5, 2003

(54) Valve block and valve block assembly for producing such a valve block

(76) Inventors: Uwe Reichert, Schluchtern (DE); Claus-Jurgen Becker, Wolfsburg (DE)

Correspondence Address: SCHIFF HARDIN & WAITE, 6600 SEARS TOWER, 233 S WACKER DR, CHICAGO, IL, 60606-6473, US

(21) Appl. No.: 10/312,746

(22) PCT Filed: Aug. 1, 2001
(86) PCT No.: PCT/DE01/02949

(30) Foreign Application Priority Data
Aug. 15, 2000 (DE) 10040559.2

(51) Int. Cl. F17D 1/00

(52) U.S. Cl. 137/271

(57) ABSTRACT

The invention relates to a valve block for at least two valves, which can be fixed inside a housing (2), comprising: an electric cabling to electric connections for the valves (20a, 20b); a pneumatic cabling to pneumatic connections for the valves; an electric plug (4), out of which the electric cabling to the electric connections extends, and; a pneumatic plug (6a, 6b), out of which the pneumatic cabling to the pneumatic connections extends. The pneumatic cabling runs at least partially inside an interchangeable insert of the housing that can be selected according to the valves and/or their function and/or the pneumatic plug comprises at least one pneumatic plug connection that can be selected according to the valves and/or their function. The invention also relates to a valve block assembly for producing such a valve block, whereby both the valves as well as the interchangeable inserts and/or the pneumatic plug connections comprise a matched coding according to which a valve block with a designated function can be produced.

### BACKGROUND OF THE INVENTION

The invention is directed to a valve block for at least two valves fixable in a housing having an electric cabling to electrical terminals for the valves and a pneumatic cabling or ducting to pneumatic terminals for the valves, and is also directed to a set of valve blocks for producing such a valve block

A plurality of valves that also partly perform different functions are often employed in a higher-ranking unit, for example in motor vehicles. Disadvantageously, these valves have hitherto usually been individually assembled, which, in particular, complicates as well as lengthens assembly and thus causes the ultimate price of the higher-ranking unit to rise.

For example, EP 0 627 349 A1 discloses a valve block of the species wherein an intermediate plate for the electrical cabling is provided between a part containing solenoid valves and a cover that covers this part. The utilization of such an intermediate plate leads to a design that is complicated and, thus, also costly.

Another valve block of the species is disclosed by EP 0 686 239 B1, this reference discloses a base plate with a pneumatic cabling or ducting in the form of channels for intake and exhaust air from connection openings in an aperture pattern suitable for the attachment of specific valves to a user and with an electrical cabling comprising an electrical installation device placed in a shaft that proceeds parallel to the pneumatic cabling. Although this known valve block can be simply and quickly assembled, it nonetheless exhibits a limited range of employment or, respectively, must be completely redimensioned for every specific application. This again is cost-intensive.

### SUMMARY OF THE INVENTION

An object of the present invention is therefore to improve the valve block of the species such that the disadvantages of the Prior Art are overcome, particularly that manufacturing as well as assembly costs are reduced and the range of employment is widened.

This object is inventively achieved by an electrical plug proceeding wherefrom the electrical cabling extends to the electrical terminals and by an pneumatic plug proceeding wherefrom the pneumatic cabling or circuit extends to the pneumatic terminals, whereby the pneumatic cabling proceeds at least partly in a replaceable insert of the housing that can be selected dependent on the valves and/or their function and/or the pneumatic plug comprises at least one pneumatic plug connector selectable dependent on the valves and/or their function.

It can thereby be provided that the housing comprises a floor part, preferably in the form of an injection molded part, whereby the floor part encompasses the electrical plug, the electrical cabling, the electrical terminals, at least a part of the pneumatic plug, at least a part of the pneumatic cabling or circuit, preferably in the form of air delivery openings and/or air delivery channels and can be or, respectively, is firmly connectable to the replaceable insert.

Embodiments of the invention can be characterized in that the replaceable insert comprises air delivery openings and/or air delivery channels that can be closed with a first cover, preferably composed of an injection molded part, and particularly weldable with ultrasound.

It can also be provided that the replaceable insert is arranged at the outside of a region of the floor part and the valves are arranged at the inside of said region of the floor part.

In addition, the pneumatic cabling and/or the pneumatic terminals can comprise air delivery openings and/or air delivery channels having a respective cross-section of a range of 1 through 6 mm×1 through 6 mm, and preferably a range of 4 through 5 mm×4 through 5 mm.

In addition, ring seals can be provided at pneumatic interfaces.

At least one check valve can also be provided in the pneumatic cabling or circuit.

Preferred developments of the invention are characterized in that the pneumatic plug comprises two pneumatic plug-type connections, whereby a first pneumatic plug-type connection can be releasably as well as lockably attached, particularly via a tongue and groove connection, to the second pneumatic plug-type connection, which is preferably a component part of the injection molded part of the floor part.

It is also inventively preferred that the floor part, particularly the selectable pneumatic plug-type connection and/or the replaceable insert, comprises or, respectively, comprise a coding that is dependent on the valves and/or their function.

It can also be provided that the electrical plug and the pneumatic plug are arranged at outside walls of the floor part that lie opposite one another.

The invention also proposes that the floor part comprises at least one access opening for the insertion of the valves and the inside of the floor part together with the valves arranged therein can be cast out, particularly with a resin, and/or can be closed, particularly latched, with a second cover, preferably composed of an injection molded part.

At least one centering aid can also be inventively provided in the floor part for each valve.

In addition, embodiments can be provided with a fastening means, particularly as a component part of the injection molded part of the floor part, and/or with a damping element, preferably in interaction with the fastening means.

It is also inventively preferred that the valves are attached in the housing via a plug connection, whereby the pneumatic valve terminals of the valves are preferably pluggable into the pneumatic terminals in the form of air delivery openings in the floor part for the replaceable insert and/or the electrical terminals in the form of contacts projecting from the floor part are pluggable into openings for the electrical valve terminals of the valves.

Three valves can be arranged in the housing of an inventive valve block.

In addition, the invention offers a set of valve block units for the production of an inventive valve block.

It can thereby be provided that the valves, on the one hand, and the replaceable inserts and/or the pneumatic plug-type connections, on the other hand, comprise a coding matched to one another, so that a valve block having specific functions is producible dependent thereon.

The invention is thus based on the surprising perception that a plurality of valves can be attached in a housing, preferably via a simple plug-type connection, given simultaneous connection to a single electrical plug as well as to a single pneumatic plug. The inventive valve block can then be easily and quickly installed into any higher-ranking unit by connecting electric cables to the single electrical plug and air hoses to the single pneumatic plug.

Advantageously, a plurality of different pneumatic cablings or circuits of the valves of the valve block are possible by employing a selectable replaceable insert and/or a selectable pneumatic plug-type connection having specific air delivery openings and/or air delivery channels in the valve block, so that standardized valve blocks for different valves and/or functions can be manufactured in, so to speak, modular organization from a set of valve block units for further work simplification. The combination versatility of valves that are employable in an inventive valve block is thereby great due to the interchangeability of the replaceable inserts and/or pneumatic plug-type connections. It is not only the employment of different valves but also the implementation of different functions by the valves that is possible due to the flexibility in the pneumatic cabling.

In order to essentially prevent a malfunction of the valve block due to incorrect assembly, at least the replaceable inserts and/or pneumatic plug-type connections inventively comprise codings dependent on the desired overall function.

For example, an inventive valve block for utilization in a motor vehicle can comprise two electro-pneumatic transducers, the one thereof serving for adjustment of a vacuum actuator in the exhaust gas return system and the other thereof serving for the control of a vacuum actuator for a turbo-supercharger control, and can comprise an electrical reversing valve in the form of a 3/2-way valve for driving a vacuum actuator for a stop flap as particularly utilized in diesel motors.

Further features and advantages of the invention derive from the following description, wherein an exemplary embodiment of the invention is explained in detail on the basis of schematic drawings.

### BRIEF DESCRIPTION OF THE DRAWINGS

FIG. 1 is a partially exploded perspective view of an inventive valve block; and

FIG. 2 is a perspective bottom view of the valve block shown in FIG. 1.

### DESCRIPTION OF THE PREFERRED EMBODIMENTS

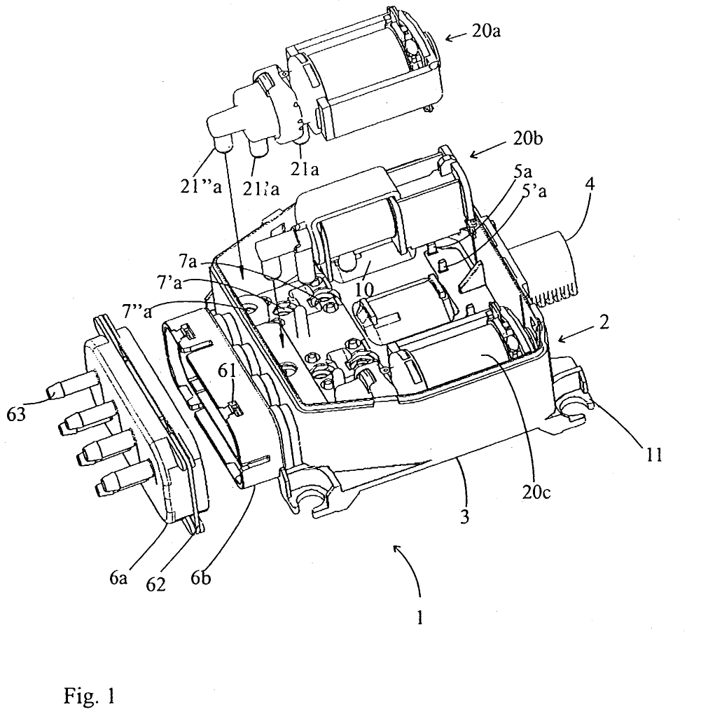

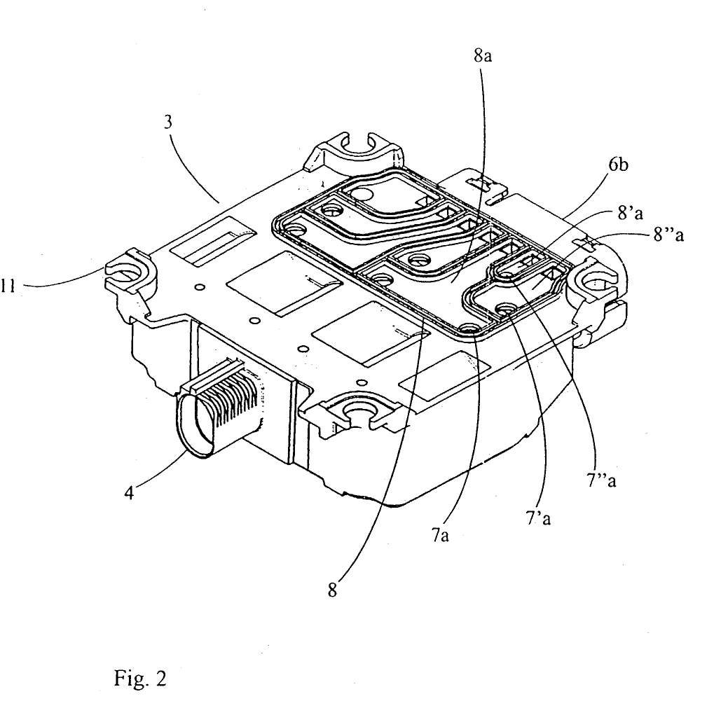

As can be derived from FIGS. 1 and 2, an inventive valve block 1 comprises a housing 2 that in turn comprises a floor or base part 3. The floor part 3 in turn contains a single electrical plug 4 at one side wall that is connected via an electrical cabling (not shown) to projecting contacts 5, 5′a as electrical terminals, and contains a single pneumatic plug 6a, 6b at a side wall lying opposite the electrical plug 4. The single pneumatic plug has interactive connections with air delivery openings 7a, 7′a, 7″a. The pneumatic cabling or circuit between the pneumatic plug fashioned in the form of two pneumatic plug-type connections 6a, 6b and the air delivery openings 7a, 7′a, 7″a representing pneumatic terminals is thereby fashioned in a replaceable insert 8 (FIG. 2) in the form of air delivery channels 8a, 8′a, 8″a. Additionally, centering aids 10 (FIG. 1) are provided in the floor part 3. Finally, the floor part 3 also comprises fastening openings 11 for installation of the valve block in a higher-ranking unit (not shown).

Three valves 20a, 20b, 20c are pluggable into the floor part 3 by inserting their pneumatic valve terminals 21a, 21′a, 21″a into the air delivery openings 7a, 7′a, 7″a with a simultaneous engagement of the contacts 5a, 5′a into electrical valve terminals (not shown).

The two pneumatic plug-type connections 6a, 6b are releasably and latchably connectable to one another via a tongue and groove connection 61, 62, whereby the outer pneumatic plug-type connection 6a comprises a plurality of hose connections 63.

The valve block 1 described in terms of its structure with reference to FIGS. 1 and 2 can be assembled from an inventive valve block set in the following way:

First, the valves 20a, 20b, 20c as well as their pneumatic cabling or circuit in the form of the replaceable insert 8 are selected according to a coding dependent on the desired function of the valve block 1.

Subsequently, the replaceable insert 8 is latched to the rest of the floor part 3. Next, the replaceable insert 8 is ultrasound-welded to a cover (not shown).

Subsequently, the valves 20a, 20b, 20c can be successively plugged into the floor part 3 upon utilization of the centering aid 10, so that an electrical contact arises between the contacts 5a, 5′a and the electrical valve terminals and a tight connection arises between the pneumatic valve terminals 21a, 21′a, 21″a and the air delivery openings 7a, 7′a, 7″a.

As soon as the valves 20a, 20b, 20c have been firmly plugged into the floor part, the floor part 3 can be cast out with resin for improving the thermal conductivity, for protection against overheating and for increasing the maximum on duration. Subsequently, another cover (not shown) can be latched to the open end of the floor part 3.

The valve block 1 can then be attached to a higher-ranking unit such as a motor vehicle by inserting screws (not shown) into the fastening openings 11 in which rubber bumpers (not shown) are additionally located for damping.

An electrical cable (not shown) can then be connected to the electrical plug 4.

Subsequently, a plurality of hoses (not shown) can be connected to the hose connections 63 of the outer pneumatic plug-type connections 6a according to a coding dependent on the selected function of the valve block 1. Next, the outer pneumatic plug-type connection 6a can be placed onto the rest of the valve block 1, whereby a corresponding emplacement is only possible when the inner pneumatic plug-type connection 6b has been selected according to the coding of the outer pneumatic plug-type connection 6a. Thus, for example, the geometry of the pneumatic plug-type connections 6a, 6b of each and every coding can be different dependent on the function of the valve block 1. The inventive valve block 1 is ready to function as soon as the pneumatic plug-type connections 6a, 6b have been connected to one another.

Both individually as well as in arbitrary combinations, the features of the invention disclosed in the above description, in the claims as well as in the drawings can be critical for realizing the various embodiments of the invention.

We claim:

1. Valve block (1) for at least two valves (20a, 20b, 20c) fixable in a housing (2) having an electric cabling from an electrical plug (4) to electrical terminals (5a, 5′a) for the valves (20a, 20b, 20c) and a pneumatic cabling (8a, 8′a, 8″a) from a pneumatic plug (6a, 6b) to pneumatic terminals (7a, 7′a, 7″a) for the valves (20a, 20b, 20c), characterized by
a replaceable insert (8) of the housing that can be selected dependent on the valves (20a, 20b, 20c) and/or their function through which the pneumatic cabling (8a, 8′a, 8″a) proceeds at least in regions from the pneumatic plug (6a, 6b), which comprises at least one pneumatic plug connector (6b) selectable dependent on the valves (20a, 20b, 20c) and/or their function, to the pneumatic terminals (7a, 7′a, 7″a) of the valves (20a, 20b, 20c), whereby the selectable replaceable insert (8) and the selectable pneumatic plug connector (6b) are releasably connectable to the housing (2).

2. Valve block according to claim 1, characterized in that the housing (2) comprises a floor part (3), preferably in the form of an injection molded part, for the acceptance of the valves (20a, 20b, 20c), whereby the floor part (3) encompasses the electrical plug (4), the electrical cabling, the electrical terminals (5a, 5′a), at least a part of the pneumatic plug (6b), at least a part of the pneumatic cabling, preferably in the form of air delivery openings and/or air delivery channels, and the pneumatic terminals (7a, 7′a, 7″a) and can be or, respectively, is firmly connectable to the replaceable insert (8).

3. Valve block according to claim 1 or 2, characterized in that the replaceable insert (8) comprises air delivery openings and/or air delivery channels (8a, 8′a, 8″a) that can be closed with a first cover, preferably composed of an injection molded part, particularly weldable with ultrasound.

4. Valve block according to one of the preceding claims, characterized in that the replaceable insert (8) is arranged at the outside of a region of the floor part (3) and the valves (20a, 20b, 20c) are arranged at the inside of said region of the floor part (3).

5. Valve block according to one of the preceding claims, characterized in that the pneumatic cabling and/or the pneumatic terminals can comprise air delivery openings and/or air delivery channels (7a, 7′a, 7″a, 8a, 8′a, 8″a) having a respective crossection of 1 through 6 mm×1 through 6 mm, preferably 4 through 5 mm×4 through 5 mm.

6. Valve block according to one of the preceding claims, characterized by ring seals at pneumatic interfaces.

7. Valve block according to one of the preceding claims, characterized by at least one check valve in the pneumatic cabling.

8. Valve block according to one of the preceding claims, characterized in that the pneumatic plug comprises two pneumatic plug-type connections (6a, 6b), whereby a first pneumatic plug-type connection (6a) can be releasably as well as lockably attached, particularly via a tongue and groove connection (61, 62), to the second pneumatic plug-type connection (6b), which is preferably a component part of the injection molded part of the floor part (3).

9. Valve block according to one of the preceding claims, characterized in that the floor part (3), particularly each selectable pneumatic plug-type connection (6a, 6b) and/or the replaceable insert (8), comprises or, respectively, comprise a coding that is dependent on the valves (20a, 20b, 20c) and/or their function.

10. Valve block according to one of the preceding claims, characterized in that the electrical plug (4) and the pneumatic plug (6a, 6b) are arranged at outsides of the floor part (3) that lie opposite one another.

11. valve block according to one of the preceding claims, characterized in that the floor part (3) comprises at least one access opening for the insertion of the valves (20a, 20b, 20c) and the inside of the floor part (3) together with the valves (20a, 20b, 20c) arranged therein can be cast out, particularly with a resin, and/or can be closed, particularly latched, with a second cover, preferably composed of an injection molded part.

12. Valve block according to one of the preceding claims, characterized by at least one centering aid (10) in the floor part (3) for each valve (20a, 20b, 20c).

13. Valve block according to one of the preceding claims, characterized by a fastening means (11), particularly as a component part of the injection molded part of the floor part (3), and/or a damping element, preferably in interaction with the fastening means.

14. Valve block according to one of the preceding claims, characterized in that the valves (20a, 20b, 20c) are attached in the housing (2) via a plug connection, whereby the pneumatic valve terminals (21, 21′a, 21″a) of the valves (20a, 20b, 20c) are preferably pluggable into the pneumatic terminals in the form of air delivery openings (7a, 7′a, 7″a) in the floor part (3) for the replaceable insert (8) and/or the electrical terminals in the form of contacts (5a, 5′a) projecting from the floor part (3) are pluggable into openings for the electrical valve terminals of the valves (20a, 20b, 20c).

15. Valve block according to one of the preceding claims, characterized in that three valves (20a, 20b, 20c) are arranged in the housing (2).

16. Valve block set for the production of a valve block according to one of the preceding claims, characterized in that the valves, on the one hand, and the replaceable inserts and/or the pneumatic plug-type connections, on the other hand, comprise a coding matched to one another, a valve block having a specific function being producible dependent thereon.
